(19) United States
(12) Patent Application Publication
(10) Pub. No.: US 2009/0259492 A1
(43) Pub. Date: Oct. 15, 2009

(54) Remote Consultation System and Method

(75) Inventor: Peter J. Cossman, Brookside, NJ (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Strategic Medical, LLC, Woodbridge, NJ (US)

(21) Appl. No.: 12/420,427

(22) Filed: Apr. 8, 2009

Related U.S. Application Data
(60) Provisional application No. 61/123,601, filed on Apr. 9, 2008.

(51) Int. Cl. G06Q 50/00; G06Q 40/00; G06Q 10/00; G06Q 30/00; G06F 17/30; G06F 15/16; G06F 3/048; G06F 17/40; H04M 11/00; H04M 15/00; H04M 1/64

(52) U.S. Cl. 705/3; 705/2; 705/4; 705/9; 705/26; 705/30; 707/100; 709/204; 715/780; 379/88.14; 379/133; 379/88.04; 707/E17.044; 707/E17.103

(57) ABSTRACT

A computer-implemented method and system for confirming that a remote consultation between a professional and a client occurred, including monitoring a remote consultation call between a professional and a client using a remote consultation system, storing information of the consultation, and confirming that the consultation took place using the stored information. The consultant can be a healthcare professional such as a doctor, and the client can be a patient.

### CROSS REFERENCE TO RELATED APPLICATION

This application is a non-provisional U.S. patent application, and claims the benefit of U.S. Provisional Application No. 61/123,601, filed Apr. 9, 2008, entitled “Remote Physician Consultation and Insurance Payment Platform,” the entirety of which is herein incorporated by reference for all purposes.

### BACKGROUND

Many patients would like to consult remotely with their physicians to obtain expeditious medical consultations, and to save the time, cost, and inconvenience associated with making office visits. The telephone is ubiquitous, user-friendly, and readily available for that purpose. Additionally, a telephone interaction allows for a “real time” personal discussion between the patient and the physician, and can facilitate the physician gaining an accurate sense of a patient's condition.

Physicians would like to be paid for telephonic consultations with patients, but third party payors such as insurance companies and government sponsored plans do not cover telephone consultations by physicians. Those parties are unwilling to pay for telephone consultations because there currently exists no way to confirm that the consultation actually took place.

### SUMMARY

A computer-implemented method and system is disclosed for confirming that a remote consultation between a consultant and a client occurred, including monitoring a remote consultation call between a consultant and a client using a remote consultation system, storing information about the consultation, and confirming that the consultation took place using the stored information. In an implementation, the consultant can be a healthcare professional such as a doctor, and the client can be a patient.

It is to be understood that both the foregoing general description and the following detailed description are exemplary and explanatory and are not intended to limit the invention as claimed.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods.

FIG. 2 is a block diagram showing an exemplary networked computing environment for use in accordance with herein described systems and methods.

FIG. 3 is a diagram showing tasks performed in connection with a remote consultation provided in accordance herein described systems and methods.

FIG. 4 is a block diagram showing cooperating exemplary parties using an exemplary system in accordance herein described systems and methods.

FIG. 5 is a block diagram of an exemplary remote consultation system for use in accordance with herein described systems and methods.

FIG. 6 is a flow diagram of an exemplary method for use in accordance with herein described systems and methods.

### DETAILED DESCRIPTION

The disclosed systems and methods can be applied in connection with remote consultations between professionals and clients in any field of endeavor, such as medicine, law, business, and the like. For purposes of illustration, the medical field has been utilized as an exemplary context in which the disclosed systems and methods are applied. In that context, although the words “doctor(s)” and “patient(s)” are used, the herein described systems and methods could be used by other healthcare professionals as well. It is contemplated that the herein described systems and methods can also be adapted for use in remote consultations between consultants and clients in other, non-healthcare related fields. All such adaptations that fall within the scope and spirit of the appended claims are intended to be covered by the claims.

Provided is a system by which professionals, such as doctors and other healthcare professionals, can consult with clients, such as patients, telephonically at a time convenient to the professionals in a secure environment that enables the consultation to be verified for billing and/or recordkeeping purposes in terms of subject matter, date, time and duration. For example, the system may be used to confirm to an insurance company or other third-party payor that the remote consultation actually occurred. Because the consultation can be recorded, it can also be used to provide evidence to professionals and/or clients in the event of a dispute in connection with a remote consultation, such as a disagreement over what was said, or an assertion of malpractice.

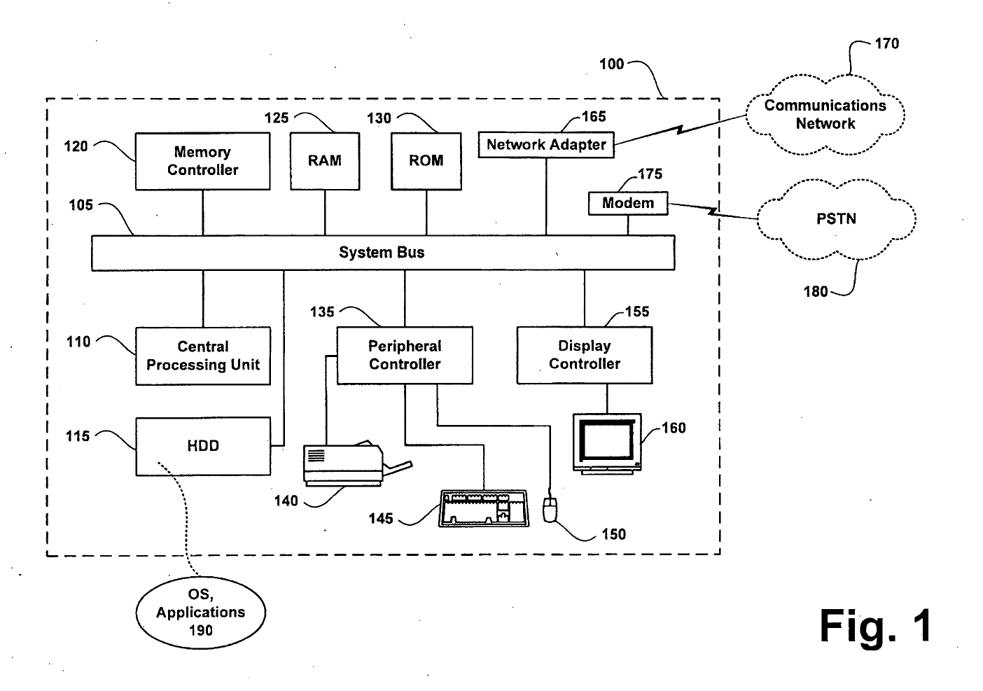

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented on a micro-electronic chip called an integrated circuit.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers (serdes) and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing a processor and its support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access to computing system 100 with means of communicating and transferring software and information electronically. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

Computing system 100 may also contain modem 175 which may be used to couple computing system 100 to a telephone communication network, such as the public switched telephone network (PSTN) 180. PSTN 180 may provide user access to computing system 100 via so-called Plain Old Telephone Service (POTS), Integrated Services Digital Network (ISDN), mobile telephones, Voice over Internet Protocol (VoIP), video telephones, and the like. It is appreciated that the modem connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments having various components and configurations.

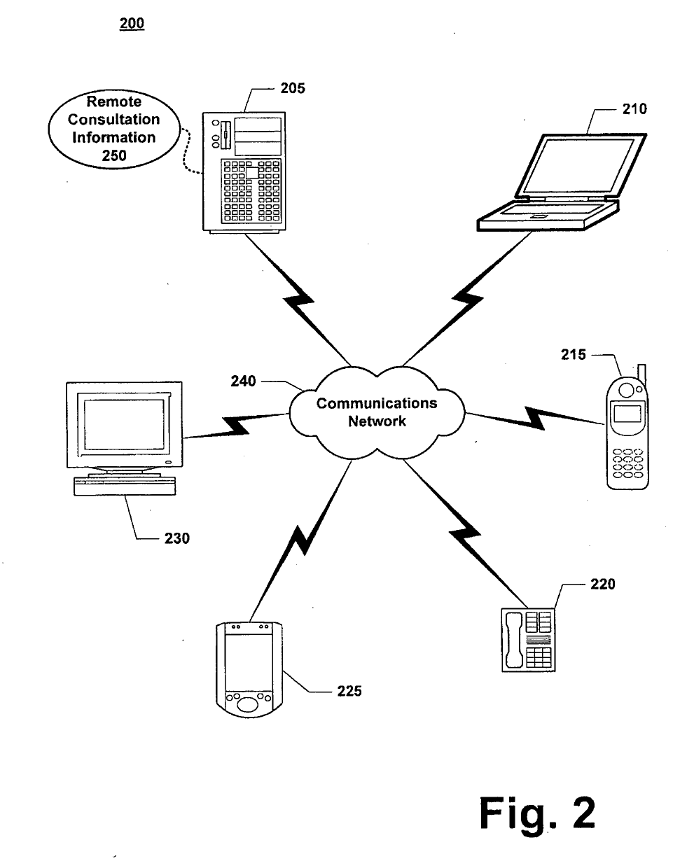

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed. As shown in FIG. 2, server 205 may be interconnected via a communications network 240 (which may include any of, or a combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data to and from client devices 210, 215, 220, 225, 230, etc. via any of a number of known protocols, such as hypertext transfer protocol (HTTP), file transfer protocol (FTP), simple object access protocol (SOAP), wireless application protocol (WAP), Skype, or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

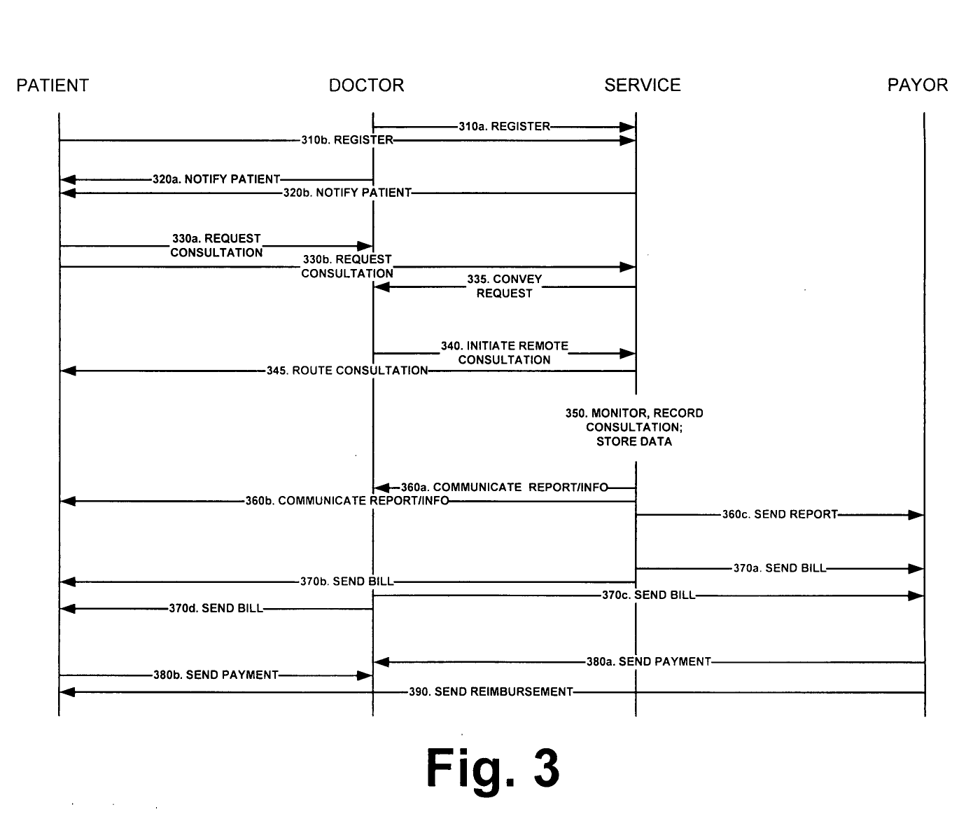

FIG. 3 shows tasks performed by exemplary parties in connection with a remote consultation provided in accordance with herein described systems and methods. Although a medical consultation between a doctor and a patient is shown, some or all of the tasks can be applied more generally in any remote consultation context wherein a remote consultation facilitation service is used to monitor a consultation between a consultant and a client, store information about the consultation, and confirm that the consultation took place using the stored information.

Referring now to FIG. 3, in step 310 a doctor registers with a remote consultation facilitation service. This can be accomplished in any convenient manner. For example, a doctor can submit to the service hardcopy forms containing doctor registration information. Alternatively, doctor registration information can be submitted electronically, such as by filling in electronic forms such as PDF forms and emailing them to the service, or submitting information online via the Internet. The doctor can also use the telephone to submit registration information, such as by speaking with a live operator, or using an interactive voice response system (IVR). The registration information can include information such as the doctor's name, telephone number, email address, and practice specific information such as licensing information, areas of expertise, types of insurance accepted, standard charges, and the like. Payment of a fee to register with the service can also be submitted. The doctor registration information can be stored, and a unique doctor identifier (doctor ID) and password can be generated by the system or otherwise established, and stored in association with the doctor registration information, for use in providing a remote consultation, for reporting, and/or for billing purposes, as described below.

After the doctor has registered with the service, patients can be notified that remote consultation is available. In step 320a, the doctor or an assistant can notify patients in any convenient manner, such as via a letter or postcard, email, telephone call, web site, or during an office visit or a call for an appointment. Alternatively, in step 320b, the doctor can provide patient contact information to the service, and the service can notify patients. For example, after registration, the doctor can provide the service with a list of contact information for patients to which a notification should be sent, and the service can send notifications to the patients on the list, such as for a fee. In either case, the notification to patients informs the patients that the doctor is available to provide remote consultations. As appropriate, the notification can include patient instructions for using the service, such as a telephone number to call to request a remote consultation, the doctor ID to use to identify the doctor with whom the patient would like to consult, and the like.

In an exemplary implementation, a patient can also register with the service, step 310b, by submitting to the service patient registration information, such as the patient's name, address, telephone number, and email address. The patient registration information can be provided in any convenient manner, such as previously described in connection with doctor registration information, and can be stored and used to provide reports and/or bills for remote consultations, as described below. A unique patient identifier (patient ID) and password can be established and stored in association with the patient registration information, for use in obtaining remote consultations, for reporting, and/or for billing purposes, as will be described. Third party payor information can also be submitted by the patient, such as insurance company name, address, group or policy number, primary insured, and the like. Such information for other payors can also be provided, such as information of a prepaid debit account for medical expenses, information of a government sponsored medical plan, or the like. The payor information can be verified by the service, and stored in association with the patient registration information. If information of more than one third party payor is provided, an appropriate order of billing payors can be determined by the service, based, for example, on deductibles, coverage limits, and the like. In an exemplary implementation, the service can determine an appropriate payment source or combination of sources to use for all remote consultations, or for select or predetermined types or categories of remote consultations, or for a particular remote consultation, to achieve a select or predetermined goal, such as to maximize payment provided to the doctor for consultations, or to minimize the out of pocket cost to the patient.

To obtain a remote consultation, the patient requests a call back from the registered doctor. In step 330a, the patient can call the doctor's office directly to request the remote consultation. For example, the patient can leave a message with the doctor or an assistant, including remote consultation request information such as a call back number, the subject matter of the requested consultation, and the like. Alternatively, in step 330b the patient can call the remote consultation facilitation service, which can convey the request to the doctor, step 335. The patient call can be answered at the service by a live operator, who can obtain the remote consultation request information, and identifying information of the doctor with whom the patient would like to consult, such as the doctor ID. The operator can also obtain and verify payor information if not already provided. If the patient has previously registered with the service, the patient can provide patient identifying information such as the patient ID and password, and patient and payor information can be retrieved from the stored patient information. Optionally, the operator can screen the call for emergencies, and can arrange for appropriate care in emergent situations, such as by calling for an ambulance, or directing the caller to an emergency room, or the like. If a remote consultation is to be arranged, the operator can communicate the request to the doctor in any convenient manner, such as by calling the doctor and leaving a message, or by sending an email to the doctor containing the consultation request information, including the call back number and appropriate payor information.

Alternatively in step 330b, the patient call can be answered at the service by an IVR system, which can prompt the patient for the remote consultation request information, including identifying information of the doctor with whom the patient would like to consult such as the doctor ID, subject matter of the consultation being requested (e.g., sore throat), payor information, and call back number. The IVR system can prompt the patient for the patient ID and password, and if the patient has previously registered with the service, can retrieve stored patient information including payor information. Responses can be provided by the patient by using a telephone keypad, or verbally. If verbally, the verbal responses can be recorded and/or converted to text using an automatic speech recognition engine, and stored. A remote consultation request tag can be generated for the request. The doctor email address can be retrieved using doctor identifying information such as the doctor ID, and an email addressed to the doctor can be generated and sent, including some or all of the responses to the IVR system prompts. For example, a recording or transcript of the call can be included with the email. The email can thus convey the remote consultation request to the doctor. Delivery and read confirmations can be requested for the email. If confirmations are not received, the email can be resent. Alternatively, an automated telephone call to the doctor can be generated and a speech synthesizer used to convey the remote consultation request and associated information to the doctor. Optionally, both an automated email and an automated call can be used. For example, an automated email can be sent requesting delivery receipt, and if no receipt is returned within a select time period, an automated call can be made.

In an exemplary implementation, the patient email address can also be retrieved using patient identifying information such as the patient ID. An email addressed to the patient can be generated and sent, which can be the same as or different from the email sent to the doctor, including some or all of the responses to the IVR system prompts, such as in a recording or transcript of the consultation request included in the email. The email to the patient can thus provide a record of the consultation request to the patient.

Optionally, incoming patient calls can be screened at the service by a live operator, and forwarded to the IVR system in non-emergency situations. The calls can be screened around the clock, or only during selected time periods, such as at night, or during holidays, evening and weekend hours, or the like.

The doctor can obtain a request for consultation by viewing and/or listening to the email and/or voice message according to a predetermined schedule or at any convenient time, and initiate the remote consultation according to a schedule or at any convenient time after receiving the remote consultation request, step 340. To do so, the doctor calls the service, and the call is answered at the service by an IVR system. The call can be a voice-only call, or an audio-video call, such as a Skype call. In an exemplary implementation, the IVR system can ask the caller to specify whether the caller is a patient or a doctor, and if a doctor, whether the doctor would like to register or would like to initiate a remote consultation. Alternatively, different telephone numbers with different IVR systems can be used for patient calls and doctor calls, and/or for registering with the service and for requesting or initiating remote consultations. In step 340, the IVR system prompts the doctor for doctor identifying information, such as the doctor ID, and for the call back number. Alternatively, the IVR system prompts the doctor for the request tag, and using the tag the associated call back number and doctor ID are retrieved. A remote consultation engine then routes the call to the call back number, step 345, and begins monitoring the consultation, step 350. The call can be routed to the call back number, for example, by placing a new call to the call back number and conferencing in the doctor.

Monitoring the consultation can include recording the start time of the call and/or the call duration, for example, using a timer. Monitoring can include making a sound recording of the call content, and/or using an automatic speech recognition (ASR) engine to convert the voices of the call to a text transcript of the consultation. At the conclusion of the consultation, the remote consultation engine can disconnect the patient and/or the doctor from the call, or can keep both the patient and the doctor on the line but disconnect them from each other, for example, in response to the doctor pressing a predetermined key on the telephone. The IVR system can prompt one or both of the doctor and the patient for comments regarding the call, and can make sound recordings and/or transcripts of the comments. For example, the doctor can dictate information such as a consultation summary, applicable Current Procedural Terminology (CPT) codes, and the like, such as might be required, for example, by an insurance company or other payor. CPT codes are maintained by the American Medical Association (AMA) and accurately represent medical and diagnostic services and the like, and are designed to communicate uniform information about medical services and procedures among physicians, coders, patients, accreditation organizations, and payors for administrative, financial, and analytical purposes.

The time and duration of the consultation, associated sound recordings and transcripts, and any other information of the call can be stored as consultation information in a storage device of the service for use, for example, in billing for the consultation and generating consultation reports. The consultation can be completed, and the consultation information stored and used, in compliance with applicable rules, regulations, and laws, such as for example, the requirements of the Health Insurance Portability and Accountability Act (HIPAA).

The stored consultation information can be used to generate reports. The reports can be sent, for example, to the patient, to the doctor, or to another party in accordance with applicable law, such as a third party payor. Such reports can be sent in response to a request for information, or automatically, such as after the consultation, or periodically, such as monthly. Alternatively, a predetermined portion of the stored consultation information can be provided to an authorized user for viewing and/or downloading, such as via a secure web site provided by a web server of the service, or via a direct connection. The user can be authorized using appropriate credentials, for example, using the ID and password established by the doctor or patient at registration.

In step 360a, stored consultation information is accessed, viewed, and/or downloaded by a doctor from the service, and/or a report is sent by the service to the doctor or retrieved by the doctor from the service. Such information or report can include any of the stored consultation information, or a predetermined doctor-accessible portion of the stored information, and/or can group and/or summarize and/or otherwise manipulate such information. For example, a monthly report can include information of all of the remote consultations given by the doctor in the previous month, grouped by patient, including transcripts of the doctor's comments made after each consultation, with a count of the number and sum of the duration of the consultations to each patient, and grand totals for all patients included in the report. The same or similar information, groupings, summaries, and the like can be provided for viewing and/or downloading by the doctor, such as via an interactive secure web site provided by the service. The doctor can use such downloaded information, for example, to establish or enhance an electronic medical record (EMR) maintained by the doctor for the patient.

In step 360b, stored consultation information is accessed, viewed, and/or downloaded by a patient from the service, and/or a report is sent by the service to the patient or retrieved by the patient from the service. As before, such information or report can include any of the stored consultation information, or a predetermined patient-accessible portion of the stored information, and/or can group and/or summarize and/or otherwise manipulate such information. For example, a monthly report can include information of all the remote consultations provided by all doctors with whom the patient has consulted in the previous month, grouped by doctor, including transcripts of the patient's comments made after each consultation, with a count of the number and sum of the duration of the consultations with each doctor, and grand totals for all doctors included in the report. The same or similar information, groupings, summaries, and the like can be provided for viewing and/or downloading by the patient, such as via an interactive secure web site provided by the service. The patient can use such downloaded information, for example, to establish or enhance an personal health record (PHR) maintained by the patient, or to retrieve information to submit to a payor for payment of or reimbursement for the remote consultation.

In step 360c, a report is sent to a payor. For example, a monthly report can include information of all the remote consultations paid for by that payor in the previous month (as discussed below), grouped, totaled and/or summarized in any convenient manner, such as by patient, doctor, geographically by city and/or state of patients and/or doctors, and the like. Reports can be sent in hardcopy form, or electronically, such as in PDF form appropriate for printing by the recipient, or in a comma separated value (CSV) file that can be read by a program used by the recipient.

The consultation information can be used to generate bills. The bills can be generated and sent by the service to the patient or other payor, or can be generated by the service and sent to the doctor to be forwarded to the patient or other payor, or can be generated by the doctor using information reported to the doctor by the service, as described above. A bill can be sent in response to a request for a bill, or automatically, such as after the consultation, or periodically, such as monthly. For example, in step 370a, a bill is sent by the service to the payor. Such a bill can include any of the stored consultation information, or can group and/or summarize such information. For example, a bill can be sent after each consultation, including the date and duration of the consultation, and a transcript of the doctor's comments. Or, a monthly bill can include information of all of the remote consultations covered by the payor in the previous month for a particular patient or doctor, with a count of the number and sum of the duration of the consultations to that patient or doctor. In step 370b, a bill is sent by the service to the patient. For example, a bill can be sent after each consultation, or monthly bills can include information of all the remote consultations received from each doctor with whom the patient has consulted in the previous month, including transcripts of the patient's comments made after each consultation, with a count of the number and sum of the duration of the consultations with each doctor. In step 360c, a bill is sent by the doctor to a payor, using information reported to the doctor by the service, as described above. In step 360d, a bill is sent by the doctor to a patient, using information reported to the doctor by the service. Those bills can be set up and sent by the doctor in any manner desired by the doctor. In an exemplary implementation, billing information can be stored with the consultation information and provided online to an authorized user.

In an exemplary implementation, information regarding patient visits to a doctor's office can optionally be provided to the service, and the service can verify conformance with payor rules and/or guidelines regarding remote consultations in view of office visits. For example, an insurance company may cover either an office visit or a remote consultation for a particular medical condition instance, but not both. Or, an insurance company may determine that payment for an initial visit or remote consultation for a condition is deemed to include payment for a follow-up visit or consultation as well. The service can verify that bills are produced in accordance with such rules and guidelines. For example, information regarding one or more office visits, including the patient condition(s) being treated and the times and dates of the visits, can be provided to the service. The service can then determine the elapsed time between each office visit and remote consultation in relation to other office visits and remote consultations, and verify that bills for remote consultations and/or office visits accord with applicable rules and guidelines. For example, the service can submit to the insurance company a bill for a remote consultation only if it occurred after a predetermined period of time from a prior remote consultation or office visit for the same condition. The service can report to the doctor information regarding remote consultations that are not covered by the insurance company, and/or send bills to the patient and/or other payor(s) for those consultations. Illustratively, the office visit information can be provided to the service by the patient when requesting a remote consultation. If so, the service may retrieve insurance guidelines and advise the patient regarding coverage for the requested consultation. Alternatively, the office visit information can be provided to the service by the doctor when calling to provide the requested consultation. If so, the service may advise the doctor regarding coverage, for example, before the doctor actually provides the consultation. In an exemplary implementation, the service and the doctor's office electronic recordkeeping system can be arranged so that the service can automatically retrieve from the doctor's office system information regarding patient office visits in conjunction with the patient's request for a remote consultation. The service can then advise the patient and/or the doctor regarding insurance coverage for the requested consultation prior to the consultation. For example, the service can advise the doctor regarding coverage in conjunction with relaying to the doctor the patient's request for a remote consultation.

Responsive to receiving the bills, the patient and/or payor can be expected to send payment to the doctor. In step 380a, payment is sent by the payor to the doctor. In step 380b, payment is sent by the patient to the doctor. If the consultation is covered by another payor, the patient can request reimbursement from the payor. In step 390, the patient is reimbursed by the payor.

The payor can be any entity that will pay at least a portion of the bills, such as an insurance company that provides coverage for remote consultations, for example. The payor can also be a government or other sponsored program that provides such coverage. Or, the payor can be a pre-paid debit account, such as an account set up by the patient with the patient's employer, into which money is deposited as the patient is paid by the employer.

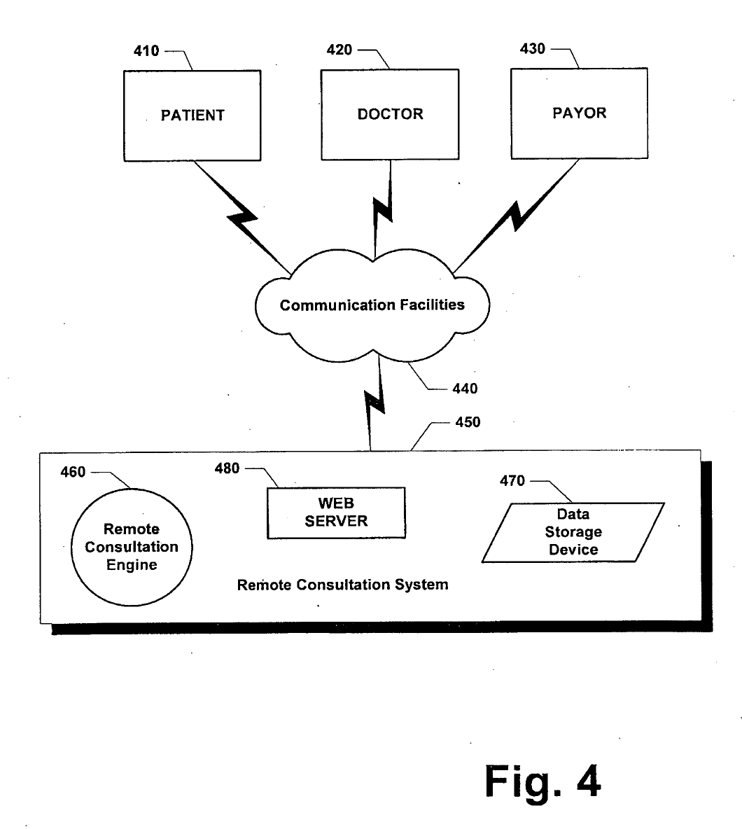

FIG. 4 is a block diagram showing cooperating parties using an exemplary remote consultation system 450 of a remote consultation facilitation service. Although a medical consultation between a doctor and a patient is shown, some or all of the tasks can be applied more generally in any remote consultation context wherein a remote consultation system is used to monitor a consultation between a consultant and a client, store information about the consultation, and retrieve at least some of the stored information and confirm that the remote consultation took place.

Referring now to FIG. 4, patient 410 and doctor 420 interact with system 450 via communication facilities 440. Facilities 440 include a telephone system by which the remote consultation is provided by the doctor 420 to the patient 410. The consultation is accomplished by the doctor 420 calling the remote consultation system 450, which routes the call to the patient 410 so the consultation can be provided. The remote consultation system 450 monitors the consultation, records and stores the time, duration, and content of the consultation, and uses the recorded information to confirm that the consultation took place by generating and sending appropriate reports and bills to the patient 410, doctor 420, and/or payor 430. The telephone system can also be used by the patient 410 to request a consultation, and by the doctor and/or the patient to register with the remote consultation facilitation service. The telephone system can also be used by the system 450 to communicate, via an IVR system and/or speech recognition engine and/or speech synthesizer, with the patient and doctor as needed, such as to call the doctor to convey a remote consultation request. In addition, communication facilities 440 can include a computer network by which the system 450 can send to the doctor 420 an email containing consultation request information such as a recording of the request and a generated request tag. The computer network can also be used to electronically send or retrieve the generated reports and bills to the patient 410, doctor 420, and/or payor 430, such as via email, or via a direct connection, or via the Internet, such as by using a secure web site provided by web server 480. Alternatively or additionally, communication facilities 440 can include mail or courier services to send hardcopies of the generated reports and bills to the patient, doctor, and/or payor. The remote consultation system 450 accomplishes its tasks under the direction of remote consultation engine 460, using information of the remote consultation stored in data storage device 470, in association with information of the patient 410, doctor 420, and payor 430 stored therein. The stored information can be stored, for example, in a relational database management system (RDBMS) that associates information of the consultation with information of the patient, doctor, and payor. In an exemplary implementation, a predetermined portion of the stored information can be provided to an authorized user via a secure web site provided by web server 480.

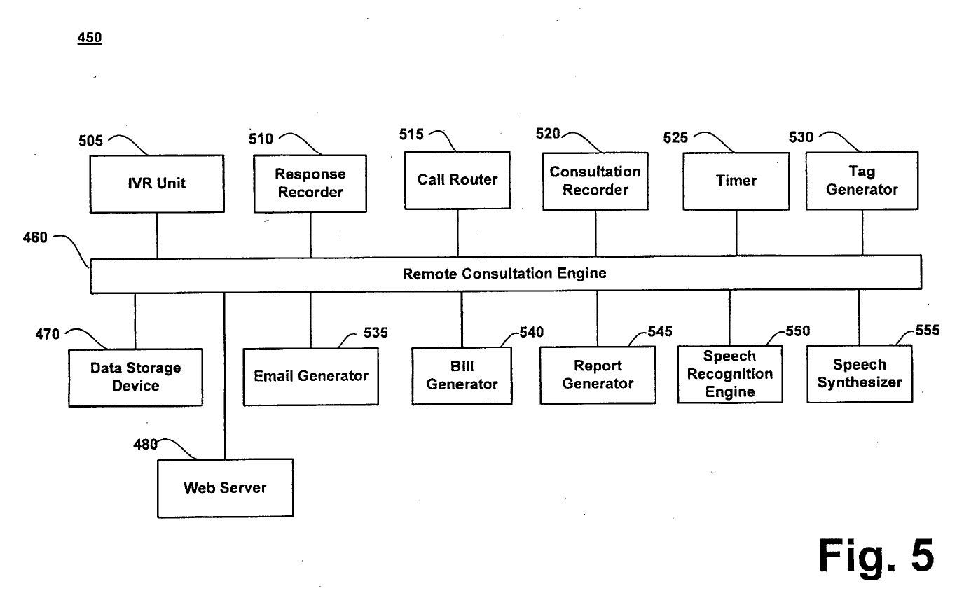

FIG. 5 is a block diagram of an exemplary remote consultation system 450, which can be implemented, for example, using a computing system such as computing system 100. Remote consultation system 450 comprises remote consultation engine 460, which can be configured to control and coordinate the actions of the other components of the system. As described previously, although an exemplary context of a medical consultation between a doctor and a patient is used for illustration, some or all of the elements of the system can be applied more generally in any remote consultation context wherein a remote consultation system is used to monitor a consultation between a consultant and a client, and confirm that the remote consultation took place.

Referring now to FIG. 5, data storage device 470 of remote consultation system 450 stores data of the remote consultation, and of the patient, the doctor, and/or the payor, in compliance with applicable rules, regulations, and laws, such as HIPAA. Remote consultation system 450 can also include web server 480, IVR unit 505, response recorder 510, call router 515, consultation recorder 520, timer 525, tag generator 530, email generator 535, bill generator 540, report generator 545, speech recognition engine 550, and speech synthesizer 555.

Web server 480 interacts with users by providing requested web pages to the users, obtaining information from the users, and providing information to the users. The web server can interact with a doctor and/or a patient to register them to use the remote consultation service. The web server can also authorize users to access consultation information stored in data storage device 470, and can present, group, summarize, and/or otherwise manipulate the stored information for viewing and/or downloading by authorized users, such as to provide reporting and/or billing information to the users.

IVR unit 505 interacts with callers by providing prompts to the callers and receiving responses to the prompts. The IVR can interact with the doctor to initiate a remote consultation. The IVR can also interact with the doctor to register the doctor with the remote consultation service, and can interact with the patient to receive a request for a remote consultation and/or to register the patient with the service. Response recorder 510 can record responses to prompts from the IVR. The recorded responses can be stored in data storage device 470.

Call router 515 is used to route a call from a doctor to a patient to initiate a remote consultation, using information received in response to one or more IVR prompts, and/or retrieved from data storage device 470. Consultation recorder 520 records the content of the consultation, and can store the recorded content in data storage device 470. Consultation recorder 520 can also record comments of the doctor and/or the patient, for example, in response to IVR prompts after the consultation is provided, and can store the recorded comments in data storage device 470. Timer 525 records the time and/or duration of the consultation, and can store the time and duration in data storage device 470. Tag generator 530 generates a unique tag for the consultation, and stores the tag in data storage device 470. The tag generator 530 can generate the tag, for example, either when a consultation request is made by a patient, or when the remote consultation is provided by a doctor.

Email generator 535 generates emails. The emails can be addressed using information received from a caller in response to one or more IVR prompts. Emails can also be addressed using information retrieved from data storage device 470. Bill generator 540 generates bills for remote consultations, using information of the remote consultations retrieved from data storage device 470. The bills can be included in emails generated by email generator 535, or can be printed and mailed using recipient information retrieved from data storage device 470. Report generator 545 generates reports regarding remote consultations, using information of the remote consultations retrieved from data storage device 470. The reports can be included in emails generated by email generator 535, or can be printed and mailed using recipient information retrieved from data storage device 470.

Speech recognition engine 550 can be used to recognize verbal input from a caller, and cause an action to be performed in accordance with the verbal input, or produce a text transcription of the verbal input. For example, a call back number can be provided verbally by a doctor and recognized by the speech recognition engine 550, and the call routed to the recognized call back number. Speech recognition engine 550 can also be used to produce a transcript of the remote consultation, and of doctor and/or patient comments provided after the consultation, and can store the transcripts in data storage device 470. Speech synthesizer 555 can generate synthesized speech from alphanumeric data. The alphanumeric data can be obtained from a caller, for example, by the caller pressing keys during a call on a telephone keypad, and can be used to verify the keyed information. Speech can also be synthesized using information retrieved from data storage device 470, for example, to provide synthesized verbal information of a remote consultation request to a doctor.

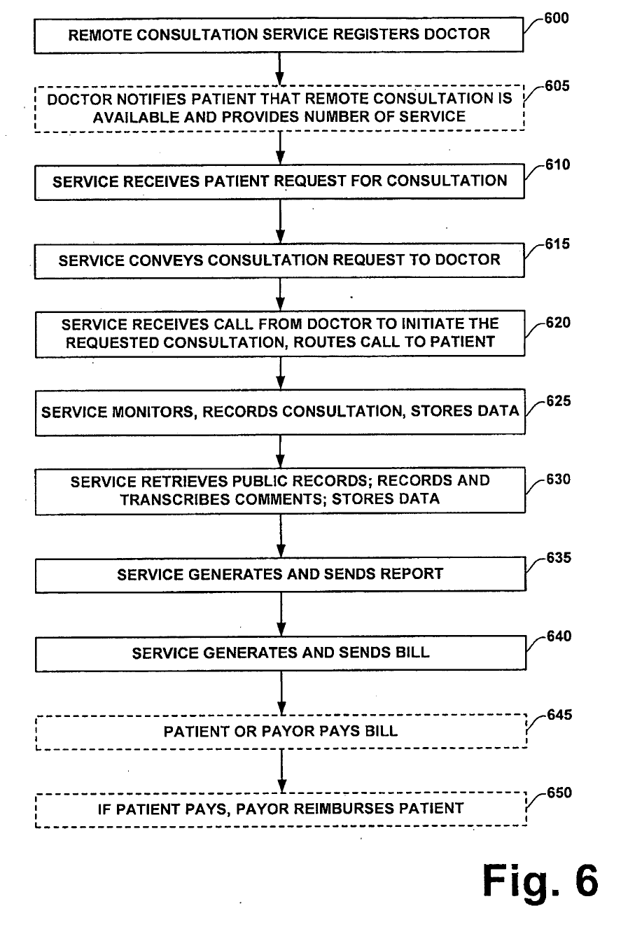

FIG. 6 is a flow diagram of a currently preferred implementation of providing a remote consultation in accordance with the herein described systems and methods, wherein tasks that are performed by an exemplary remote consultation service are presented in blocks having a solid border, and tasks that are performed by others are presented in blocks having a dashed border.

In FIG. 6, a remote consultation service that enables insurance reimbursable telephone consultations registers a doctor to use the service, step 600. Registration includes obtaining and storing the doctor's name, address, telephone number, and email address at which the doctor would like to receive emailed requests for remote consultations, and information of the doctor's charges, such as the doctor's standard charge per consultation, or charge per selected time period, such as per minute, per hour, per tenth of an hour, or the like. The service provides to the doctor a consultation telephone number and establishes an identifier (doctor ID) that can be used by the doctor's patients to request a remote consultation, and establishes a password for the doctor's use. The doctor notifies the patients that remote consultations are available, and provides the consultation number of the service and the doctor ID for the patients to use to request a remote consultation, step 605. As needed thereafter, the service receives a call to the consultation number from a patient requesting a remote consultation, step 610. The call is answered by an IVR of the remote consultation service. The IVR prompts the patient for the doctor ID, or for the identity of the doctor by name and address. The IVR also prompts the patient to disclose the nature of the consultation the patient would like to have (e.g., sore throat), the patient's insurance company and plan number to confirm coverage for a telephonic consultation, and the telephone number where the patient wants to receive the remote consultation call. A voice recording is made of the call and embedded in an email. A numeric consultation identifier (tag) is generated and attached to the email message. The doctor's email address is retrieved and the email is sent to the doctor's email address to convey the consultation request to the doctor, step 615. The service also confirms insurance coverage for a telephonic consultation.

The doctor opens the email message at his convenience, listens to the attached voice recording, obtains the consultation tag, and calls the service to initiate the remote consultation. The call is received by the service and routed to the patient, step 620. To do so, the call is answered by an IVR of the remote consultation service. The IVR prompts the doctor for the doctor ID and password, and for the consultation tag. Preferably, the ID, password, and tag are selected such that they can be entered by the doctor using the telephone keypad. The tag is used to retrieve the patient's call back number. The service then routes the call to the call back number, such as by placing a call to the call back number and conferencing in the doctor.

The system then monitors and records the consultation, and stores data of the consultation, step 625. The entire consultation, including the time and duration of the call, is recorded, and retained by the system in a secure environment that is HIPAA compliant. The system retrieves public records, records and transcribes comments, and stores that information as well, step 630. For example, a record of where the call was directed can be made through a reverse look-up feature that retrieves from public records the name and address of the owner of the call back number. In addition, after the consultation, the system can disconnect the patient, and the IVR can prompt the doctor for comments regarding the consultation, and the system can record and store the comments.

In step 635, the service generates and sends a report. The report can be a monthly report including the consultations provided by the doctor to patients in the reported month, including the name of the doctor, the telephone number to which consultation calls were made, the names and addresses to which the telephone numbers were registered, the length of the consultations, and the insurance company information for each consultation.

In step 640, the service generates and sends a bill to the participating insurance company or to the patient for each remote consultation provided via the service. The system retrieves from storage information of the consultation, including the time and duration of the consultation, the doctor's charges based on information provided by the doctor at registration, and information of the insurance company and/or the patient. A bill for the consultation is generated by the service and sent by the service to the insurance company if some or all of the doctor's charges for the remote consultation are covered, and/or to the patient if some or all of the doctor's charges for the consultation are not covered.

The patient or insurance company pays the bill by sending payment to the doctor, step 645. If the patient pays charges that are covered by the insurance company, the patient can notify the insurance company and the insurance company can reimburse the patient for the paid covered charges, step 650.

It is understood that the herein described systems and methods are susceptible to various modifications and alternative constructions. There is no intention to limit the herein described systems and methods to the specific constructions described herein. Rather, the herein described systems and methods are intended to cover all modifications, alternative constructions, and equivalents falling within the scope and spirit of the appended claims.

It should also be noted that the herein described systems and methods can be implemented using a wide variety of computing and communication environments (including both wired and wireless telephone and/or computer network environments). The various techniques described herein may be implemented in hardware alone or hardware combined with software. Preferably, the herein described methods are implemented using a programmable computing system that can access one or more communications network, and includes one or more processors, storage mediums storing instructions readable by the processors to cause the computing system to do work, at least one input device, and at least one output device. Computing hardware logic cooperating with various instruction sets are applied to data to perform the functions described herein and to generate output information. The output information is applied to one or more output devices. Programs used by the exemplary computing hardware may be implemented using one or more programming languages, including high level procedural or object oriented programming languages, assembly or machine languages, and/or compiled or interpreted languages. Each such computer program is preferably stored on a storage medium or device (e.g., solid state or optical or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

It is to be understood that while the invention has been described above in conjunction with currently preferred specific embodiments, the description and examples are intended to illustrate and not limit the scope of the invention, which is defined by the scope of the appended claims.

What is claimed is:

1. A computer-implemented method of confirming that a remote consultation between a professional and a client occurred, comprising:
monitoring a remote consultation between a professional and a client using a remote consultation system of a remote consultation facilitation service;
storing information of the consultation by the remote consultation system; and
confirming that the consultation took place using the stored information.

2. The method of claim 1, wherein the professional is a healthcare professional, the client is a patient, and the recorded information is stored in accordance with the Health Insurance Portability and Accountability Act (HIPAA).

3. The method of claim 1, further comprising:
prior to the monitoring, registering the professional with the service.

4. The method of claim 1, further comprising:
prior to the monitoring, requesting the consultation by the client calling the service and providing to the service information identifying the professional and at least one of:
the nature of the consultation requested,
a payment source providing coverage for the consultation and payment plan information, and
a telephone number where the client wants to receive a call from the professional for the consultation.

5. The method of 4, further comprising if the payment source is an insurance company and insurance plan information is provided, confirming insurance coverage for a remote consultation.

6. The method of claim 4, further comprising:
generating a request tag for the requested consultation;
generating an email responsive to the request including information of the request and the request tag; and
sending the email to an email address of the professional.

7. The method of claim 6, further comprising making a sound recording of the request call and including the recording in the email.

8. The method of claim 6, further comprising:
receiving and reviewing the email by the professional; and
initiating the consultation at a time selected by the professional, by the professional calling the remote consultation system and indicating the consultation request was received, and providing the request tag to the system.

9. The method of claim 8 further comprising:
the system:
routing the call to the client using information provided by the client;
recording at least one of a time of the call, a duration of the call, and content of the call; and
storing the recorded information.

10. The method of claim 9, further comprising transcribing at least a portion of the content of the call, and storing the transcription with the recorded information.

11. The method of claim 9, further comprising:
dictating, by at least one of the professional and the client, comments regarding the call, and storing at least one of a recording of the comments and a transcription of the comments with the recorded information.

12. The method of claim 9, further comprising:
retrieving information from publicly available records based on a destination identifier of the call; and
storing the retrieved information in association with the recorded information.

13. The method of claim 9, further comprising:
generating at least one report by the service including at least a portion of the stored information; and
communicating the at least one report to a respective at least one of the professional, the client, and an insurance company providing coverage for the remote consultation.

14. The method of claim 9, further comprising:
generating a bill by one of the service and the professional, including at least a portion of the stored information; and
sending the bill to at least one of the client and a payment source.

15. The method of claim 14, wherein the payment source is at least one of an insurance company providing coverage for the remote consultation, a sponsored payment plan, and a debit account.

16. The method of claim 13, wherein the report is in at least one of a hardcopy form and an electronic form.

17. A computer readable storage medium storing computer readable instructions which, when executed on a computer, instruct the computer to cause a method to be performed, the method comprising:
monitoring a remote consultation between a professional and a client using a remote consultation system;
recording at least one of a time of the consultation, a duration of the consultation, and content of the consultation as monitoring information;
storing the recorded monitoring information;
generating at least one of a bill and a report, including at least a portion of the stored information; and
communicating the bill and/or the report to at least one of the client, the professional, and a payment source providing payment for the remote consultation.

18. The method of claim 17, wherein the payment source is at least one of an insurance company providing coverage for the remote consultation, a sponsored payment plan, and a debit account.

19. The computer readable storage medium of claim 17, wherein the professional is a healthcare professional, the client is a patient, and the recorded monitoring information is stored in accordance with requirements of the Health Insurance Portability and Accountability Act.

20. The computer readable storage medium of claim 17, wherein the method further comprises:
prompting a caller with an interactive voice response (IVR) unit of the system to indentify the caller as a client or a professional:
in the case the caller is a client:
prompting the client to provide at least one of:
information identifying the client,
information identifying the professional,
the nature of the consultation requested,
a payor and payment plan information, and
a telephone number where the client wants to receive a call back from the professional;
recording the client responses to the prompts;
generating a tag associated with the requested consultation;
generating an email to the professional, including the tag and at least a portion of the recorded responses; and
sending the email to an email address of the professional; and
in the case the caller is a professional, prompting the professional to provide one of:
registration information including the professional's name, address, telephone number, and the email address; and
consultation initiation information including the tag; and
in the case consultation initiation information is provided by the professional:
routing the call to the call back number,
retrieving information from publicly available records based on the call back number,
storing the retrieved information in association with the recorded monitoring information, and
including at least a portion of the retrieved information with the bill and/or report.

21. The computer readable storage medium of claim 17, wherein the method further comprises:
presenting a user of the remote consultation system with a web page from a web server of the system to identify the user as a client or a professional:
in the case the user is a client, prompting the client to provide one of:
client registration information including the client's name, address, telephone number, and the email address; and
a previously established client identifier (ID) and client password, and information identifying a remote consultation;
in the case client registration information is provided by the client, establishing the client ID and the client password; and
in the case the client ID, the client password, and the consultation identifying information are provided by the client, authorizing the client to access a predetermined client portion of stored information of the consultation; and
in the case the user is a professional, prompting the professional to provide one of:
professional registration information including the professional's name, address, telephone number, and the email address; and
a previously established professional identifier (ID) and professional password, and information identifying a remote consultation;
in the case professional registration information is provided by the professional, establishing the professional ID and the professional password; and
in the case the professional ID, the professional password, and the consultation identifying information are provided by the professional, authorizing the professional to access a predetermined professional portion of stored information of the consultation.

22. A remote consultation facilitation system comprising:
a monitoring device for monitoring a remote consultation between a professional and a client and producing monitoring information;
a storage device coupled to the monitoring device for storing information about the consultation including the monitoring information; and
a remote consultation engine coupled to the storage device for retrieving at least some of the stored information about the remote consultation and confirming that the remote consultation took place.

23. The system of claim 22, wherein the professional is a healthcare professional, the client is a patient, and the stored information is stored in accordance with requirements of the Health Insurance Portability and Accountability Act.

24. The system of claim 22, further comprising:
a bill generator coupled to the remote consultation engine for generating a bill from at least a portion of the retrieved information.

25. The system of claim 22, further comprising:
an interactive voice response (IVR) unit for prompting a caller for at least one of registration information from a professional to register the professional with the system, consultation request information from a client to request a remote consultation, and consultation initiation information from a professional to initiate the requested remote consultation;
a response recorder for recording the responses to the IVR prompting;
a timer for determining at least one of the remote consultation start time and duration as time information;
a consultation recorder for recording content of the remote consultation;
a storage device for storing the responses, time information, and content as remote consultation data; and
a report generator for generating at least one report from at least a first portion of the stored data,
wherein the remote consultation engine is coupled to at least one of the IVR, the response recorder, the timer, the consultation recorder, the storage device, the report generator, and the bill generator, and wherein the bill includes at least a second portion of the stored data.

26. The system of claim 25, further comprising:
a consultation tag generator for generating a tag associated with the consultation request information; and
an email generator for generating and sending an email to the professional including the tag and at least a portion of the consultation request information.

27. The system of claim 25, wherein the IVR prompts at least one of the client and the professional for comments associated with the remote consultation, further comprising:
a transcription engine for transcribing at least a portion of the consultation content and the comments as transcribed text,
wherein the storage device stores at least a portion of the comments and the transcribed text.

28. The system of claim 22, further comprising a web server coupled to the storage device and to the remote consultation engine for providing a user of the system with a web site for:
identifying the user as a client or a professional;
registering the user;
establishing an ID and password for the user;
authorizing the user to access a predetermined portion of stored information of a consultation; and
providing the authorized user with access to the predetermined portion of the stored consultation information.
